(19) United States
(12) Patent Application Publication
(10) Pub. No.: US 2024/0325929 A1
(43) Pub. Date: Oct. 3, 2024

(54) METHOD FOR PREDICTING LIFE TIME VALUE OF USER PLAYING MOBILE F2P GAME AND COMPUTING SYSTEM FOR PERFORMING THE SAME

(71) Applicant: Bagelcode, Inc., Seoul (KR)

(72) Inventors: Joo Hyun KIM, Redmond, WA (US); Jun Woo YUN, Busan (KR); Won Ryeol KWAK, Seoul (KR)

(21) Appl. No.: 18/617,777

(22) Filed: Mar. 27, 2024

(30) Foreign Application Priority Data
Mar. 28, 2023 (KR) 10-2023-0040681

(51) Int. Cl. A63F 13/79; A63F 13/92

(52) U.S. Cl. CPC A63F 13/79; A63F 13/92

(57) ABSTRACT

A method for predicting life time value (LTV) of a user playing a mobile F2P game and a computing system for performing the same are disclosed. According to an embodiment of the present disclosure, it is possible to accurately predict LTV of a user using various types of features, while addressing the curse of dimensionality problem that may occur when using a very large number of features.

### CROSS-REFERENCE TO RELATED APPLICATION

The present application claims priority under 35 U.S.C. § 119 (a) to Korean patent application number 10-2023-0040681 filed on Mar. 28, 2023, in the Korean Intellectual Property Office, the entire disclosure of which is incorporated by reference herein.

### BACKGROUND

### 1. Technical Field

The present disclosure relates to a method for predicting life time value of a user playing a mobile F2P game using an artificial neural network and a computing system for performing the same.

### 2. Related Art

Mobile F2P games are a form of game provided for free on mobile devices, and generate revenue through in-app purchase (IAP) and advertising. Through IAPs, players may get improved game play experiences, such as playing games more smoothly or acquiring special rewards. Mobile F2P games have various themes and genres, and examples thereof include online social casino games. Online social casino games are a genre of F2P games where users access the Internet and interact with each other to enjoy casino games. Slot machines in social casino games are very similar to physical slot machines, but are implemented as virtual slot machines because they may be played online, and players may connect through the Internet to play the games. A representative example of an online social casino game is Bagel Code's “Club Vegas Slots,” a game where the goal is to win more coins through jackpots by playing slot machines of various types and themes using the coins held by the user.

Meanwhile, by looking at the latest trends of mobile game companies or game publishers, it may be seen that all actions of the user are stored as raw data. By using this wealth of stored data, it is possible to understand in-depth the action patterns of the game user and the reasons behind the actions. The reason action patterns are important is because most mobile F2P game companies rely on IAP revenue. This is because by understanding the action of the users, not only may company growth be promoted by maximizing profits from user payments, but users may be managed through a customer relationship management (CRM) system and valuable users may be secured through marketing.

The industry early on introduced business KPIs to quantify, analyze and predict user action, and among these, lifetime value (LTV) is used as a key indicator needed to quantify profits. This is a key element in estimating the value of users and is the first indicator introduced in the marketing field. LTV of a user indicates how much revenue the user will generate until he or she permanently quits the game.

The value of any user may be evaluated by using LTV and additional auxiliary indicators using LTV (ROAS: LTV compared to marketing cost investment). In addition, this allows predicting the return on investment in the future, and it helps to evaluate marketing efficiency to execute better advertisements. In addition, through this indicator, in-game management may be carried out, such as preventing withdrawal from the game, encouraging purchases, and increasing satisfaction within the game. In other words, LTV prediction may be seen as the driving force itself to attract and manage valuable users through effective marketing and encourage payments to increase overall sales and net profit of the company.

Currently, the industry is using various approaches to predict LTV, such as RFM, BYTD, machine learning, deep learning using action sequence data, user embedding, and solving imbalance problems. Existing methods are used to predict LTV, but they lack a deep and broad understanding of various types of users and their actions, and are unable to use multiple data sources.

### SUMMARY

A technical object to be achieved by the present disclosure is to provide a method for predicting life time value (LTV) of a user playing a mobile F2P game using an artificial neural network and a computing system for performing the same. To this end, a methodology called a user embedding model and a model structure are presented. A general-purpose user embedding may be created using various data sources, through which multiple downstream tasks such as LTV prediction may be performed.

According to an aspect of the present disclosure, there is provided a computing system for predicting life time value (LTV) of a user playing a mobile F2P game, including: a storage module configured to store a prediction model for predicting LTV of a user; an acquisition module configured to acquire subscription information of a user to be predicted, which is input by the user to be predicted or obtainable from a terminal of the user to be predicted at a point of time when the user to be predicted subscribes to a service providing the mobile F2P game, action information, which is information indicating that the user to be predicted has performed various actions within the mobile F2P game over a predetermined period of time, and status information, which is various numerical information about the user to be predicted managed within the mobile F2P game; and a prediction module configured to input data on the subscription information of the user to be predicted, latest data on the status information of the user to be predicted, time-series data on the status information of the user to be predicted, and time-series data on the action information of the user to be predicted to the prediction model, and predict LTV of the user to be predicted based on a result output by the prediction model, wherein the prediction model includes a first deep neural network (DNN) configured to receive the data on the subscription information of the user to be predicted through an input layer; an autoencoder configured to receive the latest data on the status information of the user to be predicted through an input layer; a first convolution layer configured to receive the time-series data on the status information of the user to be predicted; a first UNET configured to receive data output from the first convolution layer through an input layer; a first dense layer connected to an output layer of the first UNET; a first Time2Vec layer configured to receive the time-series data on the status information of the user to be predicted; a first multi-layer transformer configured to receive data output from the first Time2Vec layer through an input layer; a second DNN configured to receive data output from the first multi-layer transformer through an input layer; a first weighted sum layer for calculating a weighted sum of data output from the first dense layer and data output from the second DNN; a second convolution layer configured to receive the time-series data on the action information of the user to be predicted; a second UNET configured to receive data output from the second convolution layer through an input layer; a second dense layer connected to an output layer of the second UNET; a second Time2Vec layer configured to receive the time-series data on the action information of the user to be predicted; a second multi-layer transformer configured to receive data output from the second Time2Vec layer through an input layer; a third DNN configured to receive data output from the second multi-layer transformer through an input layer; a second weighted sum layer for calculating a weighted sum of data output from the second dense layer and data output from the third DNN; a concatenation layer for concatenating data output from the first DNN, data output from the autoencoder, data output from the first weighted sum layer, and data output from the second weighted sum layer; a skip-connected autoencoder configured to receive data output from the concatenation layer through an input layer; and a third dense layer connected to an output layer of the skip-connected autoencoder.

In an embodiment, the subscription information of the user to be predicted may include at least some of country, language, operating system, and inflow path, the action information of the user to be predicted may be an action value related to the user to be predicted performing each of a plurality of actions of interest the user to be predicted is able to perform within the mobile F2P game over a predetermined period of time, and the status information of the user to be predicted may be a plurality of status values related to the user to be predicted measured when the user to be predicted performs each of the plurality of actions of interest, wherein the plurality of actions of interest include at least some of action of playing a slot machine by paying a predetermined amount of coins held, action of purchasing in-game goods by paying cash, action of logging into the game, action of receiving rewards from various events, action of completing daily missions to increase user re-connection, action of watching in-game advertisements, action of using in-game chat, action of sharing game screenshots through SNS, action related to friends, action related to subscribed clubs, action related to in-game pop-ups, action of clicking within the game, action related to in-app messages, action of entering the slot machine, and action of entering an in-game screen other than the slot machine, and the plurality of status values includes at least some of coins held, level, LTV, the number of purchases, coin acquisition amount, the number of level-ups, time taken from the last logout to a recent login, tier, total game activity time, the number of friends, and respective values of detailed statistics.

In an embodiment, in the remaining layers except the third dense layer among the layers constituting the prediction model, a kernel initializer may be set to He_Normal, and an activation function may be set to LeakyReLU.

In an embodiment, the third dense layer is configured to output all prediction results for LTV from day 1 to day N, where N is a size of the third dense layer.

In an embodiment, the computing system may further include a training module configured to train the prediction model by inputting each of a plurality of training data into the prediction model, wherein each of the plurality of training data includes data on subscription information of a corresponding user to be trained, latest data on status information of the user to be trained, time-series data on the status information of the user to be trained, and time-series data on action information of the user to be trained, and LTV of the user to be trained is used as a prediction value of the prediction model.

According to another aspect of the present disclosure, there is provided a computing system for training a prediction model for predicting life time value (LTV) of a user playing a mobile F2P game, including: a storage module configured to store a prediction model for predicting LTV of a user; an acquisition module configured to acquire subscription information, action information, and status information of each of a plurality of users to be trained; and a training module configured to train the prediction model by inputting training data corresponding to each of the plurality of users to be trained into the prediction model, wherein the training data corresponding to the user to be trained includes data on the subscription information of the user to be trained, latest data on the status information of the user to be trained, time-series data on the status information of the user to be trained, and time-series data on the action information of the user to be trained, and LTV of the user to be trained is labeled with a prediction value of the prediction model, wherein the subscription information of the user to be trained is information which is input by the user to be trained or obtainable from a terminal of the user to be trained at a point of time when the user to be trained subscribes to a service providing the mobile F2P game, the action information of the user to be trained is information indicating that the user to be trained has performed various actions within the mobile F2P game over a predetermined period of time, and the status information of the user to be trained is various numerical information about the user to be trained managed within the mobile F2P game, and wherein the prediction model includes a first deep neural network (DNN) configured to receive data on subscription information of a user to be predicted through an input layer; an autoencoder configured to receive latest data on status information of the user to be predicted through an input layer; a first convolution layer configured to receive time-series data on the status information of the user to be predicted; a first UNET configured to receive data output from the first convolution layer through an input layer; a first dense layer connected to an output layer of the first UNET; a first Time2Vec layer configured to receive time-series data on the status information of the user to be predicted; a first multi-layer transformer configured to receive data output from the first Time2Vec layer through an input layer; a second DNN configured to receive data output from the first multi-layer transformer through an input layer; a first weighted sum layer for calculating a weighted sum of data output from the first dense layer and data output from the second DNN; a second convolution layer configured to receive time-series data on action information of the user to be predicted; a second UNET configured to receive data output from the second convolution layer through an input layer; a second dense layer connected to an output layer of the second UNET; a second Time2Vec layer configured to receive the time-series data on the action information of the user to be predicted; a second multi-layer transformer configured to receive data output from the second Time2Vec layer through an input layer; a third DNN configured to receive data output from the second multi-layer transformer through an input layer; a second weighted sum layer for calculating a weighted sum of data output from the second dense layer and data output from the third DNN; a concatenation layer for concatenating data output from the first DNN, data output from the autoencoder, data output from the first weighted sum layer, and data output from the second weighted sum layer; a skip-connected autoencoder configured to receive data output from the concatenation layer through an input layer; and a third dense layer connected to an output layer of the skip-connected autoencoder.

According to another aspect of the present disclosure, there is provided a method for predicting life time value (LTV) of a user playing a mobile F2P game, including: acquiring, by a computing system in which a prediction model for predicting LTV of a user, subscription information of a user to be predicted, which is input by the user to be predicted or obtainable from a terminal of the user to be predicted at a point of time when the user to be predicted subscribes to a service providing the mobile F2P game, action information, which is the number of times the user to be predicted performed various actions within the mobile F2P game over a predetermined period of time, and status information, which is various numerical information about the user to be predicted managed within the mobile F2P game; and inputting, to the prediction model, data on the subscription information of the user to be predicted, latest data on the status information of the user to be predicted, time-series data on the status information of the user to be predicted, and time-series data on the action information of the user to be predicted, and predicting LTV of the user to be predicted based on a result output by the prediction model, wherein the prediction model includes a first deep neural network (DNN) configured to receive the data on the subscription information of the user to be predicted through an input layer; an autoencoder configured to receive the latest data on the status information of the user to be predicted through an input layer; a first convolution layer configured to receive the time-series data on the status information of the user to be predicted; a first UNET configured to receive data output from the first convolution layer through an input layer; a first dense layer connected to an output layer of the first UNET; a first Time2Vec layer configured to receive the time-series data on the status information of the user to be predicted; a first multi-layer transformer configured to receive data output from the first Time2Vec layer through an input layer; a second DNN configured to receive data output from the first multi-layer transformer through an input layer; a first weighted sum layer for calculating a weighted sum of data output from the first dense layer and data output from the second DNN; a second convolution layer configured to receive the time-series data on the action information of the user to be predicted; a second UNET configured to receive data output from the second convolution layer through an input layer; a second dense layer connected to an output layer of the second UNET; a second Time2Vec layer configured to receive the time-series data on the action information of the user to be predicted; a second multi-layer transformer configured to receive data output from the second Time2Vec layer through an input layer; a third DNN configured to receive data output from the second multi-layer transformer through an input layer; a second weighted sum layer for calculating a weighted sum of data output from the second dense layer and data output from the third DNN; a concatenation layer for concatenating data output from the first DNN, data output from the autoencoder, data output from the first weighted sum layer, and data output from the second weighted sum layer; a skip-connected autoencoder configured to receive data output from the concatenation layer through an input layer; and a third dense layer connected to an output layer of the skip-connected autoencoder.

In an embodiment, the method may further include acquiring a plurality of training data; and training the prediction model by inputting each of the plurality of training data into the prediction model, wherein each of the training data includes data on subscription information of a corresponding user to be trained, latest data on status information of the user to be trained, time-series data on the status information of the user to be trained, and time-series data on action information of the user to be trained, and LTV of the user to be trained is used as a prediction value of the prediction model.

According to another aspect of the present disclosure, there is provided a method for training a prediction model for predicting life time value (LTV) of a user playing a mobile F2P game, including: acquiring, by a computing system storing a prediction model for predicting LTV of a user, subscription information, action information, and status information of each of a plurality of users to be trained; and training the prediction model by inputting training data corresponding to each of the plurality of users to be trained into the prediction model, wherein the subscription information of the user to be trained is information which is input by the user to be trained or obtainable from a terminal of the user to be trained at a point of time when the user to be trained subscribes to a service providing the mobile F2P game, the action information of the user to be trained is information indicating that the user to be trained has performed various actions within the mobile F2P game over a predetermined period of time, and the status information of the user to be trained is various numerical information about the user to be trained managed within the mobile F2P game, and wherein the prediction model includes a first deep neural network (DNN) configured to receive data on subscription information of a user to be predicted through an input layer; an autoencoder configured to receive latest data on status information of the user to be predicted through an input layer; a first convolution layer configured to receive time-series data on the status information of the user to be predicted; a first UNET configured to receive data output from the first convolution layer through an input layer; a first dense layer connected to an output layer of the first UNET; a first Time2Vec layer configured to receive the time-series data on the status information of the user to be predicted; a first multi-layer transformer configured to receive data output from the first Time2Vec layer through an input layer; a second DNN configured to receive data output from the first multi-layer transformer through an input layer; a first weighted sum layer for calculating a weighted sum of data output from the first dense layer and data output from the second DNN; a second convolution layer configured to receive time-series data on action information of the user to be predicted; a second UNET configured to receive data output from the second convolution layer through an input layer; a second dense layer connected to an output layer of the second UNET; a second Time2Vec layer configured to receive the time-series data on the action information of the user to be predicted; a second multi-layer transformer configured to receive data output from the second Time2Vec layer through an input layer; a third DNN configured to receive data output from the second multi-layer transformer through an input layer; a second weighted sum layer for calculating a weighted sum of data output from the second dense layer and data output from the third DNN; a concatenation layer for concatenating data output from the first DNN, data output from the autoencoder, data output from the first weighted sum layer, and data output from the second weighted sum layer; a skip-connected autoencoder configured to receive data output from the concatenation layer through an input layer; and a third dense layer connected to an output layer of the skip-connected autoencoder.

According to another aspect of the present disclosure, there is provided a computer program installed in a data processing device and recorded on a non-transitory recording medium for performing the method described above.

According to another aspect of the present disclosure, there is provided a computing system including: a processor; and a memory, wherein the memory is configured to store a program which, when executed by the processor, causes the computing system to perform the method described above.

According to the technical idea of the present disclosure, it is possible to provide a method for predicting life time value (LTV) of a user playing a mobile F2P game and a computing system for performing the same.

Additionally, according to an embodiment of the present disclosure, there is an effect of being able to accurately predict LTV of the user by using various types of features.

According to an embodiment of the present disclosure, by constructing an artificial intelligence model architecture by adopting various methods to address the curse of dimensionality problem, there is an effect of addressing the curse of dimensionality problem that may occur when using a very large number of features.

### BRIEF DESCRIPTION OF THE DRAWINGS

In order to more fully understand the drawings cited in the detailed description of the present disclosure, a brief description of each drawing is provided.

FIG. 1 is a diagram illustrating a schematic configuration of a computing system in accordance with a technical idea of the present disclosure.

FIG. 2 is a diagram illustrating a structure of a prediction model in accordance with an embodiment of the present invention.

FIGS. 3 and 4 are diagrams illustrating detailed structures of some of components of FIG. 2, respectively.

FIG. 5 is a diagram schematically illustrating a physical configuration of a computing system in accordance with an embodiment of the present disclosure.

FIG. 6 is a diagram illustrating a method for training a prediction model for predicting life time value of a user playing a mobile F2P game in accordance with an embodiment of the present disclosure.

FIG. 7 is a diagram illustrating an example of a method for predicting life time value of the user playing the mobile F2P game using the prediction model previously trained through a process of FIG. 6.

### DETAILED DESCRIPTION

Since the present disclosure may be modified variously and have various embodiments, specific embodiments will be illustrated in the drawings and described in detail in the detailed description. However, this is not intended to limit the present disclosure to specific embodiments, and it should be understood to include all modifications, equivalents, and substitutes included in the spirit and scope of the present disclosure. In describing the present invention, if it is determined that a detailed description of related known technologies may obscure the gist of the present disclosure, the detailed description will be omitted.

Terms such as first and second may be used to describe various components, but the components should not be limited by the terms. The terms are used merely for the purpose of distinguishing one component from another component.

Terms used in the present application are used only to describe a particular embodiment and are not intended to limit the present disclosure. Singular expressions include plural expressions unless the context clearly means otherwise.

In this specification, it should be understood that terms such as “include” or “have” are intended to designate the presence of features, numbers, steps, operations, components, parts, or combinations thereof described in the specification, but do not preclude the possibility of the presence or addition of one or more other features, numbers, steps, operations, components, parts, or combinations thereof.

Additionally, in this specification, when one component ‘transmits’ data to another component, this means that the component may transmit the data directly to the other component or transmit the data to the other component through at least one other component. Conversely, when one component ‘directly transmits’ data to another component, it means that the data is transmitted from the component to the other component without going through still other component.

Hereinafter, the present disclosure will be described in detail focusing on embodiments of the present disclosure with reference to the accompanied drawings. The same reference numerals in each drawing indicate the same member.

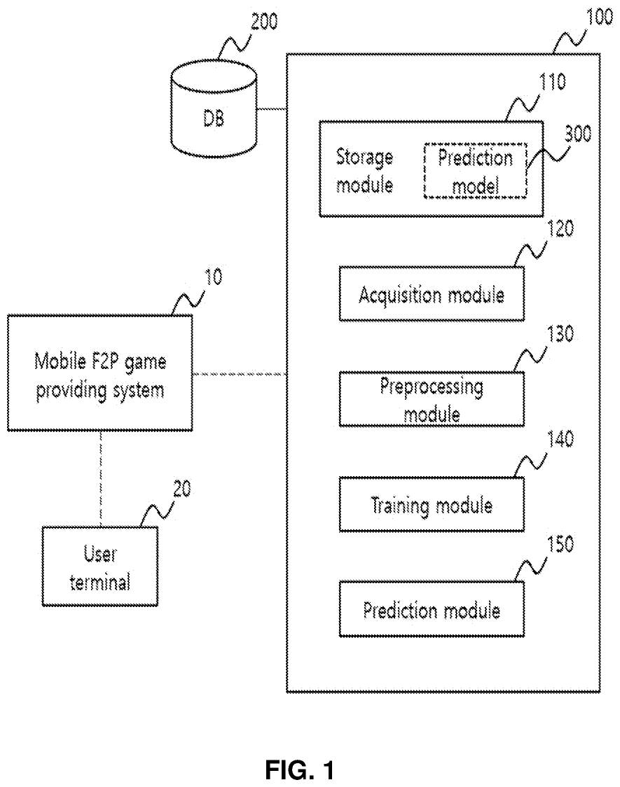

FIG. 1 is a diagram illustrating a schematic configuration of a computing system in accordance with a technical idea of the present disclosure.

A computing system 100 may predict life time value (LTV) of a user playing a predetermined mobile F2P game. The computing system 100 may predict the LTV of the user using a predetermined prediction model 300. The prediction model 300 may be a complex of a plurality of artificial neural networks, as will be described later.

The computing system 100 for implementing this technical idea may have a configuration as shown in FIG. 1 logically. FIG. 1 is a diagram for explaining a logical configuration of the computing system 100 in accordance with an embodiment of the present disclosure. Referring to FIG. 1, the computing system 100 may include a storage module 110, an acquisition module 120, a preprocessing module 130, a training module 140, and a prediction module 150. According to embodiments of the present disclosure, some of the above-described components may not necessarily correspond to components essential for implementation of the present disclosure, and in addition, according to embodiments, the computing system 100 may include more components than these. For example, the computing system 100 may further include a control module (not shown) for controlling other components (e.g., the storage module 110, acquisition module 120, preprocessing module 130, training module 140, prediction module 150, etc.) included in the computing system 100, a communication module (not shown) for communicating with an external device (not shown), and the like.

The computing system 100 may refer to a logical configuration provided with hardware resources and/or software necessary to implement the technical idea of the present disclosure, and does not necessarily refer to one physical component or one device. In other words, the computing system 100 may refer to a logical combination of hardware and/or software provided to implement the technical idea of the present disclosure, and if necessary, it may be implemented as a set of logical components to implement the technical idea of the present disclosure by being installed in devices separated from each other and performing each function. In addition, the computing system 100 may refer to a set of components implemented separately for each function or role to implement the technical idea of the present disclosure. For example, the storage module 110, the acquisition module 120, the preprocessing module 130, the training module 140, and the prediction module 150 may each be located in different physical devices or may be located in the same physical device. In addition, according to implementation examples, a combination of software and/or hardware constituting each of the storage module 110, the acquisition module 120, the preprocessing module 130, the training module 140 and the prediction module 150 may also be located in different physical devices, and components located in different physical devices may be organically combined with each other to implement each of the modules.

In addition, in the present specification, a module may refer to a functional and structural combination of hardware for carrying out the technical idea of the present disclosure and software for driving the hardware. For example, it may be easily inferred by an average expert in the technical field of the present disclosure that the module may refer to a logical unit of a predetermined code and hardware resources for executing the predetermined code, and does not necessarily refer to a physically connected code or a single type of hardware.

An average expert in the technical field of the present disclosure will easily infer that the computing system 100 refers to a data processing device with computing capabilities to implement the technical idea of the present disclosure, and that in general, not only data processing devices that may be accessed by clients through a network, but also any device that may perform a specific service, such as a personal computer or mobile terminal, may be defined as a computing system.

The mobile F2P game is a type of game provided for free on mobile devices, and hereinafter, an online social casino game, which is a representative example of a mobile F2P game, will be used as an example, but the technical idea of the present disclosure is not limited thereto, and the technical idea of the present disclosure may be equally applied to other types of mobile F2P games, unless it is a special embodiment that may only be applied to online social casino games. Meanwhile, online social casino games are online social casino games based on slot machines, and players (users) may use the coins they hold to play virtual slot machines and aim to earn more coins.

The mobile F2P game may be provided by a predetermined mobile F2P game providing system 10.

The player (user) may access the predetermined mobile F2P game providing system 10 through his or her terminal 20 and play the mobile F2P game through a web browser and/or a dedicated app. Event log data may be generated whenever the user subscribes to the mobile F2P game providing system, takes a specific action within the mobile F2P game, or changes the status of the user, and event log data may be recorded in a database (DB) 200.

The acquisition module 120 may acquire subscription information, status information, and action information of each user playing the mobile F2P game based on event log data in the DB 200, and train the prediction model 300 or predict the LTV of the user based thereon. In addition, if necessary for training the prediction model 300, the acquisition module 120 may additionally acquire the LTV of each user.

In an embodiment of the present disclosure, user information for training the prediction model 300 or predicting the LTV of the user may be divided into three types according to the processing type and five types according to the category.

In detail, according to the processing type, user information may be divided into subscription information, status information, and action information.

Subscription information is information that is input by the user or obtainable from the terminal 20 of the user at the time point when the user subscribes to the mobile F2P game providing service, and may be information about the country, language, operating system, inflow path, or the like of the user.

Action information may be information on which the user to be predicted performed various actions within the mobile F2P game over a predetermined period of time. In other words, the action information may be information indicating what actions the user to be predicted performed within the mobile F2P game. In particular, the action information may be information on the user performing each of a plurality of actions of interest selected from among all actions that the user is able to perform within the mobile F2P game over a predetermined period of time.

In an embodiment, the plurality of actions of interest may be broadly classified into five categories of base, social, pop-up, click, and enter, and in particular, in online social casino games, each category may have the following.

TABLE 1

| Category | Action of interest |
|---|---|
| Base | Spin: Action of spinning a slot machine by paying a |
| | predetermined amount of coins held, and according to the |
| | results of the spin, an appropriate amount of coins may be |
| | acquired. It is the most basic element of social casino games. |
| | Purchase: Action of purchasing in-game goods by paying cash |
| | Login: Action of running a game on a device |
| | Reward: Action of receiving rewards from various events |
| | Mission: Action of completing a challenge (daily mission to |
| | increase user reconnection) |
| | Monetization: Action of watching in-game advertisements |
| Social | Chat: Action of using in-game chat |
| | Share: Action of sharing game screenshots through social |
| | media |
| | Friend: Action related to in-game friends |
| | Club: Action related in-game clubs |
| Popup | Popup: Action related to in-game pop-ups |
| | IAM: Action related to in-app messages |
| Click | Click: Action of clicking within the game |
| Enter | Enter: Act of entering a screen other than a slot machine, such |
| | as the lobby or season event. |
| | Slot Enter: Action of entering a slot machine |

Since action information is information about the actions measured over a predetermined period of time, it may be time-series information. In other words, action information may be measured at predetermined periods, and the computing system 100 may acquire action information for each period. The period may be calculated differently according to the prediction period.

In addition, status information may be various numerical information about each user managed within the mobile F2P game. In particular, the status information may be a plurality of status values related to the user measured when the user performs each of the plurality of actions of interest, and the plurality of status values may be at least some of coins held, level, LTV, the number of purchases, coin acquisition amount, the number of level-ups, time taken from the last logout to a recent login, tier, total game activity time, the number of friends, and respective values of detailed statistics. The status information may also be time-series information because it is information that changes over time. In other words, status information may also be measured at predetermined periods, and the computing system 100 may acquire status information for each period.

The information that the computing system 100 inputs into the prediction model 300 is data based on subscription information, status information, and action information of each user as described above, and subscription information, status information, and action information of each user may explain most situations that may occur in the game. In other words, how users came in, when and how many actions they took, and what their status was at the time of those actions may be reflected in the LTV prediction through subscription information, status information, and action information of each user. In addition, it is possible to capture what actions were taken and how they were performed through five classifications (base, social, pop-up, click, enter). In other words, numerous information generated by users may be standardized into a designated format and easily used for model training and LTV prediction.

Meanwhile, the training module 140 may input training data corresponding to each of a plurality of users to be trained into the prediction model 300 to train the prediction model.

The plurality of users to be trained may be all users who have played the mobile F2P game, or may be a portion of them according to embodiments. In most mobile games, a significant number of users tend to leave within a short period of time. Therefore, in order to improve model prediction performance, among inactive users, those who are determined not to have even started playing the game in earnest may be removed and the remaining users may be determined as users to be trained. For example, the computing system 100 may determine that a user with more than 100 slot spins by 7 days after subscription is a user to be trained.

The training data corresponding to the user to be trained includes data on subscription information of the user to be trained, latest data on status information of the user to be trained, time-series data on the status information of the user to be trained, and time-series data on action information of the user to be trained, and LTV of the user to be trained is used as a prediction value of the prediction model,

According to embodiments, the data on the subscription information of the user to be trained, the latest data on the status information of the user to be trained, the time-series data on the status information of the user to be trained, and the time-series data on the action information of the user to be trained may be the subscription information of the user to be trained, the latest status information of the user to be trained, the series status information of the user to be trained, the time-series action information of the user to be trained itself, respectively, but may be preprocessed data thereof in other embodiments. In the latter case, the preprocessing module 130 may be responsible for preprocessing each information. The preprocessing module 130 may include a LabelEncoder and a StandardScaler. A LabelEncoder refers to a preprocessor that converts categorical data into a numeric type, and a StandardScaler refers to a preprocessor that makes numeric data have a normal distribution with a mean of 0 and variance of 1.

According to embodiments, the LabelEncoder and StandardScaler may be implemented as included in the prediction model 300.

In addition, time-series data refers to a series of data acquired and combined at predetermined intervals (e.g., 6 hours, 1 hour, 10 minutes, etc.) over a predetermined period of time (e.g., from the time of subscription to 1 day, 1 week, until the present, etc.), and latest data refers to the most recently acquired data among the acquired time-series data.

Meanwhile, after the prediction model 300 is trained, the prediction module 150 may input data on subscription information of a predetermined user (user to be predicted) whose LTV is to be predicted, latest data on status information of the user to be predicted, time-series data on status information of the user to be predicted, and time-series data on action information of the user to be predicted into the prediction model 300, and may predict the LTV of the user to be predicted based on the results output by the prediction model 300 and output it through an external device (not shown). The external device is a device connected to the computing system 100 through a predetermined external interface and may be a display device connected to the computing system, but is not limited thereto, and may be another computing device connected to the computing system 100 through a network.

The prediction module 150 may output all prediction results for LTV from day 1 to day N. At this time, N is the size of the output layer of the prediction model 300.

Further, the storage module 110 may store the prediction model 300 and may further store various information necessary to implement the technical idea of the present disclosure.

In the present specification, when the computing system 100 predicts the LTV of the user, it may mean that the artificial neural network stored in the computing system 100 performs a series of automated processes of receiving input data (data on subscription information, latest data on status information, time-series data on status information, and time-series data on action information) corresponding to the user and outputting output data defined in the present specification.

In addition, in the present specification, the artificial neural network may refer to a set of information representing a series of design items defining the artificial neural network. As is well known, the artificial neural network may include an input layer, a plurality of hidden layers, and an output layer. The artificial neural network may be defined by a function, a filter, a stride, a weight factor, and the like for defining each of these layers. In addition, the output layer may be defined as a fully connected FeedForward layer. The design details of each layer constituting the artificial neural network are widely known. For example, known functions may be used for each of the number of layers to be included in the plurality of layers, a convolution function for defining the plurality of layers, a pooling function, and an activation function, and a neural network configuration (layers and functions) separately defined to implement the technical idea of the present disclosure may be used.

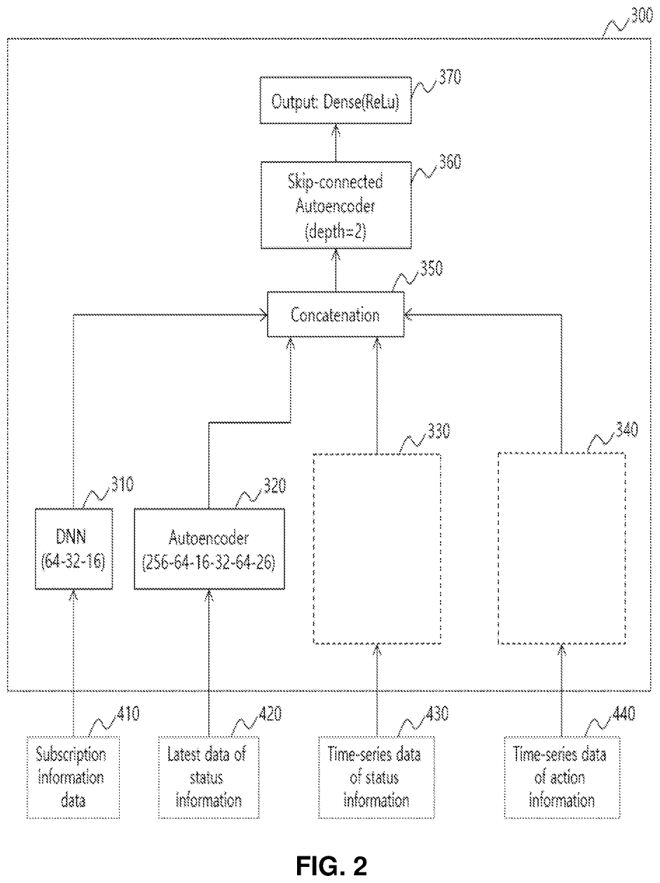

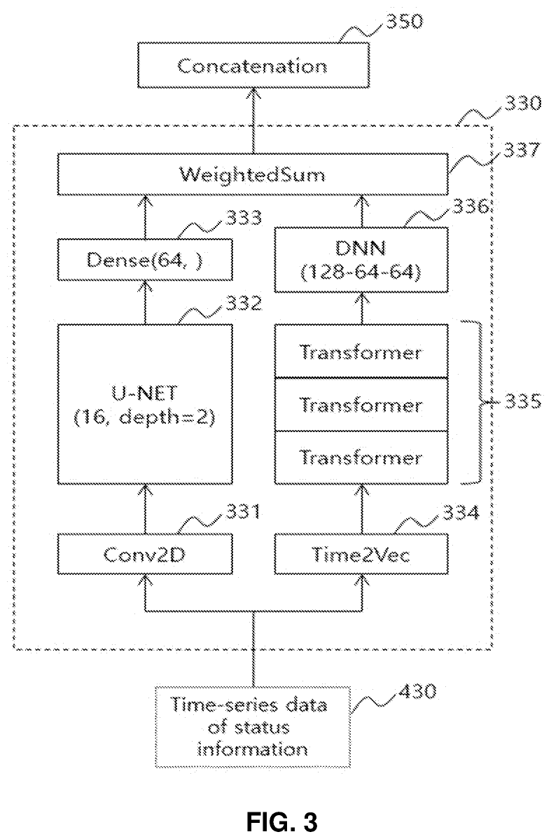

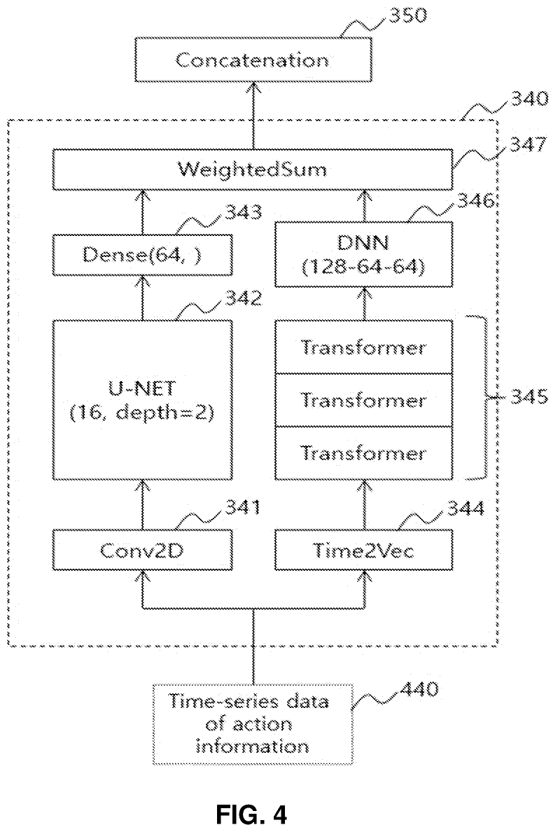

FIG. 2 is a diagram illustrating a structure of the prediction model 300 in accordance with an embodiment of the present invention. FIGS. 3 and 4 are diagrams illustrating detailed structures of some of the components 330 and 340 of FIG. 2, respectively.

For all model layers of the prediction model 300 shown in FIGS. 2 to 4, except for the output layer 370, the kernel initialization method is set to He_Normal (kernel initializer=he_normal), and the activation function is set to LeakyReLU (activation_function=leaky_relu).

Referring to FIG. 2, the prediction model 300 may include a first deep neural network 310 configured to receive data 410 on subscription information of a user through an input layer. In an embodiment, the first deep neural network 310 may be a deep neural network in which the hidden layers have sizes of 64, 32, and 16, respectively, and the dropout may be 0.25. Since the data 410 has a small number of features and is simple, a main value may be sufficiently extracted with the deep neural network (DNN) and the dropout (0.25). User information may be later combined with the action information of the user to derive insights about the correlation and complex interaction of the information.

Meanwhile, the prediction model 300 may further include an autoencoder 320 configured to receive latest data 420 on status information of the user through an input layer, and a first sub-structure 330 configured to receive time-series data 430 on status information of the user.

An autoencoder is an artificial neural network structure mainly used in unsupervised learning methodologies, and is an artificial neural network structure used in unsupervised learning for efficient data encoding. The autoencoder learns a function to approximate the output value to the input value, extracts features for the input data through an encoder, and reconstructs the original data through a decoder.

In an embodiment, the autoencoder 320 may include an encoder part having hidden layers of 256, 64, and 16, respectively, and a decoder part having hidden layers of 32, 64, and 256, respectively, and the dropout may be 0.1.

As shown in FIG. 3, the first sub-structure 330 may include a first convolution layer 331 configured to receive time-series data 430 for status information of a user, a first UNET 332 configured to receive data output from the first convolution layer 331 through an input layer, a first dense layer 333 connected to an output layer of the first UNET 332, a first Time2Vec layer 334 configured to receive time-series data 430 for the status information of the user, a first multi-layer transformer 335 configured to receive data output from the first Time2Vec layer through an input layer, a second DNN 336 configured to receive data output from the first multi-layer transformer 335 through an input layer, and a first WeightedSum layer 337 for calculating a weighted sum of data output from the first dense layer 333 and data output from the second DNN 336.

The first Time2Vec layer 334 outputs the result of concatenating the data input to the corresponding layer (i.e., 430) and the data replaced with Time2Vec.

The UNET is the same form as the autoencoder, but is a structure in which the encoder and the decoder are connected at the same level.

To briefly describe the difference between autoencoder, skip-connected autoencoder, and UNET, the autoencoder has a form in which the feature is reduced by the encoder and then increased by the decoder, and UNET has the same structure as the autoencoder, but has a difference in that there is a connection between the encoder and decoder. Skip-connected autoencoder (SAE) has a common feature with UNET in that there is a skip-connection between the encoder and decoder, but there is a difference in that UNET requires the encoder and decoder of the same layer to be the same size, while SAE does not need to be the same size.

In an embodiment, the first UNET 332 may have a size of 16 and a depth of 2, and the size of the first dense layer 333 may be 64.

In addition, in an embodiment, the first multi-layer transformer 335 may have a structure in which three transformer encoders are stacked, and the drop out may be 0.1, and the second DNN 336 may be a DNN in which the hidden layers have sizes of 128, 64, and 64, respectively, and the drop out may be 0.2.

Data on the status information of the user is divided into the latest data 420 on the status information of the user and the time-series data 430 on the status information of the user, wherein the time-series data 430 represents a status from installation of a game service to day N, and the latest data 420 has only the latest status of the user among the time-series data. Since the status of the user changes from time to time, predicting the future requires considering both the amount of change in the status (time-series) and the latest status. For this reason, modeling is done by dividing one data into two.

The latest data 420 of the status information passes through the autoencoder 320. The curse of dimensionality problem is solved through the autoencoder structure. Time-series data 430 uses two different model structures. The first is a model that passes through the Conv2D layer 331 and then the UNET 332 and uses the dense layer 333 as the output. In the second, the existing data 430 is combined with data replaced with Time2vec 334 and exported to the multi-layer transformer structure 335 with multi-headed attention. The data passed through the transformer 335 passes through the DNN 336 to produce an output. Afterwards, the different outputs are combined with the WeightedSum layer 337.

Referring again to FIG. 2, the prediction model 300 may further include a second sub-structure 340 configured to receive time-series data 440 on the action information of the user, and the second sub-structure 340 configured to receive time-series data 440 on the action information of the user, may have the same structure as the first sub-structure 330. As shown in FIG. 4, the second sub-structure 340 may include a second convolution layer 341 configured to receive the time-series data 440 on the action information of the user, a second UNET 342 configured to receive data output from the second convolution layer 341 through an input layer, a second dense layer 343 connected to an output layer of the second UNET 342, a second Time2Vec layer 344 configured to receive the time-series data 440 on the action information of the user, a second multi-layer transformer 345 configured to receive data output from the second Time2Vec layer 344 through an input layer, a third DNN 346 configured to receive data output from the second multi-layer transformer 345 through an input layer, and a second WeightedSum layer 347 for calculating a weighted sum of data output from the second dense layer 343 and data output from the third DNN 346.

In an embodiment, the second UNET 342 may have a size of 16 and a depth of 2, and the first dense layer 333 may have a size of 64. In addition, in an embodiment, the second multi-layer transformer 345 may have a structure in which three transformer encoders are stacked, the drop-out may be 0.1, and the second DNN 346 may be a DNN in which the hidden layers have sizes of 128, 64, and 64, respectively, and the drop-out may be 0.2.

Meanwhile, the prediction model 300 may include a concatenation layer 350 for concatenating data output from the first DNN 310, data output from the autoencoder 320, data output from the first sub-structure 330, and data output from the second sub-structure, an SAE 360 configured to receive data output from the concatenation layer 350 through an input layer, and a third dense layer 370 connected to an output layer of the SAE.

In other words, the prediction model 300 concatenates data from the previous four model architectures 310, 320, 330, and 340 and sends it to the SAE 360. Instead of using a separate function for concatenation, the form of concatenating with the concatenation layer is taken, and the SAE model 360 performs the task of extracting insights from different data.

Finally, the output layer is configured to match the predicted goal. For example, if the prediction model 300 is a model for LTV prediction of day 14, a ReLU dense layer 370 of size 14 is used. The peculiar thing at this time is that not only the LTV of day 14 is predicted, but all LTVs from day 1 to day 14 are predicted.

The first specialty of the prediction model 300 as described above is standard scaling of the data, and that the kernel initialization method is set to He normal for all model layers except the output layer 370, and the activation function is set to Leaky ReLU. This is to normalize the data and solve the vanishing gradient problem that comes from the curse of dimensionality problem by using the appropriate activation function and kernel initializer.

The standard scaling makes it easy to compare and analyze multi-dimensional values, prevents overflow or underflow of data, and reduces the condition number of the covariance matrix of the independent variable, thereby improving stability and convergence speed in the optimization process.

The reason why the kernel initialization method is set to He normal is as follows. The vanishing/exploding gradient problem, the most common problem of deep learning, may cause problems of overfitting/underfitting or convergence to a local minimum, and a weight initialization method may be used as one of the methods for solving the problem. Therefore, it is very important to initialize weights in deep learning. Each neuron (node) has a weight value, which is learned and used to solve problems as a form of ‘knowledge’. The value it is initialized to is not independent of the subsequent process, and there are synergistic combinations. If initialization is 0, learning does not occur. The mere fact that all nodes have the same value is problematic, and since that value is zero, it is fatal to multiplication. If initialization is set to a value that is too large or too small, learning will be difficult. For example, if the initialization is set to a very small value, the weight is also very small, making learning difficult. To solve this, the latest paper uses the Xavier (or Golorot) initialization, named after Xavier Glorot, and the He initialization method proposed by Kaiming He.

The second specialty of the prediction model 300 is that it considers not only the change in status (time-series) but also the latest status. Since the status of the user changes from time to time, predicting the future correctly requires considering both the amount of change in the status (time-series) and the latest status. By considering both, the prediction model 300 may understand how the latest status was reached through changes in the status.

The third specialty of the prediction model 300 is that it uses not only the UNET but also the transformer structure when processing time-series data. By solving the curse of dimensionality problem through UNET, it not only solves the problems of denoising, data compression, and local optimization, but also helps predict LTV by learning what action will occur next. UNET has an encoder-decoder structure, which trains based on whether data may be regenerated. In other words, regenerating chronological action data means understanding which actions lead to the next action, and using this, actions that are directly or indirectly related to LTV, such as the next purchase action, may be predicted. Transformer models may be efficiently trained for both correlations between features and relationships and interactions between actions in time order. It also captures long-range dependencies, allowing training to reflect changes in action/status from the time of installation to the latest data.

The fourth specialty of the prediction model 300 is that it combines outputs from different model architectures within the same data using the WeightedSum layers 337 and 347. Through the WeightedSum layers 337 and 347, the model may be trained to determine the ratio at which the data is to be combined. In the related art, it is common to construct a model by fixing a ratio, but the prediction model 300 according to the present disclosure is configured such that the prediction model 300 may learn whether to take the UNET structure aiming to solve the curse of dimensionality problem according to the training data importantly or whether to take the transformer structure that best learns the interaction between the features importantly, and thus there is a specialty in that the model may be stably trained even when the features are additionally introduced, the prediction targets are changed, or the tendency of the data is changed.

The fifth specialty of the prediction model 300 is that SAE is used when combining various data. In addition to the advantages of an autoencoder, this has the additional advantage of minimizing data loss using skip-connection. Skip connection is to add the output of the encoder layer to the input of the decoder layer at the same level. It is meaningful data because there has already been data compression and denoising such as autoencoder, UNET, and dropout for each data, and if the data is further compressed through the autoencoder, significant data loss occurs, so skip-connection is used. Instead, by taking the form of a two-layer Dense+BatchNorm layer, it is possible to extract key insights and interactions between key information extracted from each data.

The sixth specialty of the prediction model 300 is that it predicts all LTVs from day 1 to day N. Usually, in field work or papers, it is common to predict only the LTV on day 1. However, the performance was better and the model was more stable when predicting all LTVs from day 1 to day N than when predicting only LTV on day N. It complements model prediction values through target leakage and makes it operate more stably. In other words, it may be seen to solve the problems of vanishing/exploding gradient and convergence to a local minimum. For example, when predicting LTV on day 28 using data up to day 14, if all LTVs from day 1 to 28 are predicted, since the 1 to 14 LTV answers are included in the data used for training, it is the same as looking at half the answer sheet. Through this, it is possible to reliably predict the remaining day 14 to 28.

The seventh specialty of the prediction model 300 is that various methods are adopted to solve the curse of dimensionality problem.

The curse of dimensionality problem refers to a problem in which the problem calculation method grows exponentially as the mathematical space dimension (number of variables) increases. As the dimension increases, the distance between data increases and the empty space increases, showing the phenomenon of spatial sparseness. Usually, general machine learning models invest resources into feature engineering. Feature engineering refers to the process of selecting or creating only features that are directly or indirectly related to the prediction problem or that are primarily used in prediction. Not only does feature engineering require a lot of resources, but modeling using it is unstable because it cannot respond to constantly changing data. Therefore, after only essential feature engineering was performed in the prediction model 300 according to the technical idea of the present disclosure, various methods were adopted to solve the remaining problems in the model.

The methods adopted in the prediction model 300 are as follows.
He_Normal, Leaky_ReLU: Conventionally, glorot or zero, and ReLU are used, while the prediction model 300 uses He_Normal and Leaky_ReLU.
Conv2D: Data is first pooled via Conv2D at the front end of UNET, which may be seen as a peculiar method of the prediction model 300.
UNET: In general, the UNET structure is not often used for non-image information. The processing of time-series data as an image is a specialty of the prediction model 300.
SAE: This may be seen as a peculiar method of the prediction model 300. Skip-connection is a method rarely found in other methods that use the existing autoencoder.

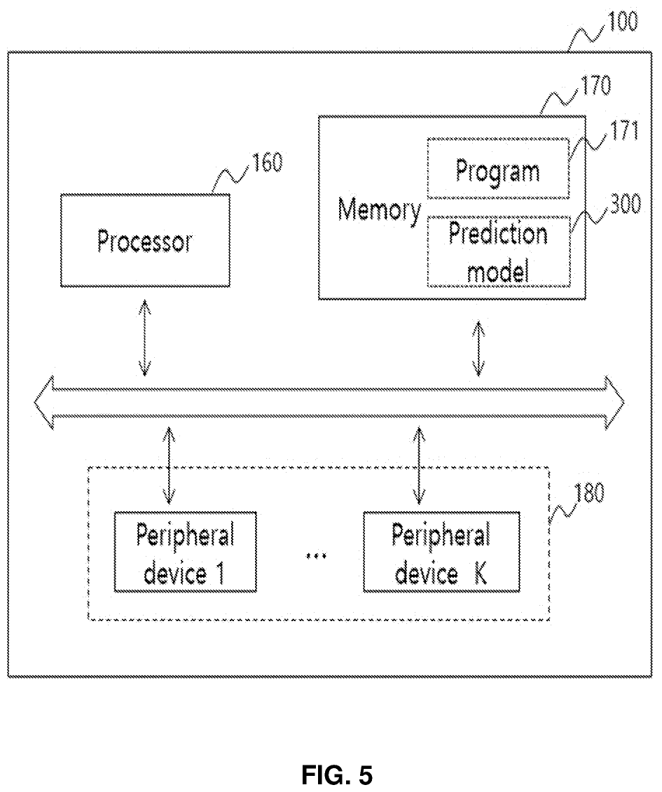

FIG. 5 is a diagram schematically illustrating a physical configuration of the computing system 100 in accordance with an embodiment of the present disclosure.

As shown in FIG. 5, the computing system 100 may include a processor 160 and a memory 170. The processor 160 may refer to an arithmetic device capable of driving a program 171 for implementing the technical idea of the present disclosure, and the processor 160 may predict the LTV of the user by using the program 171 and the prediction model 300 defined by the technical idea of the present disclosure.

The processor 160 may include a GPU as well as a CPU.

The memory 170 may refer to a data storage means capable of storing the program 171 and the prediction model 300, and may be implemented as a plurality of storage means according to an embodiment. In addition, the memory 170 may include not only a main memory device included in the computing system 100 but also a temporary storage device or memory that may be included in the processor 160.

Although the computing system 100 is shown in FIG. 5 as being implemented as a single physical device, an average expert in the technical field of the present disclosure may easily infer that a plurality of physical devices may be organically combined as needed to implement the computing system 100 according to the technical idea of the present disclosure.

In an embodiment, the computing system 100 according to the technical idea of the present disclosure may be installed in a predetermined parent system to implement the technical idea of the present disclosure. The parent system may be the mobile F2P game providing system 10.

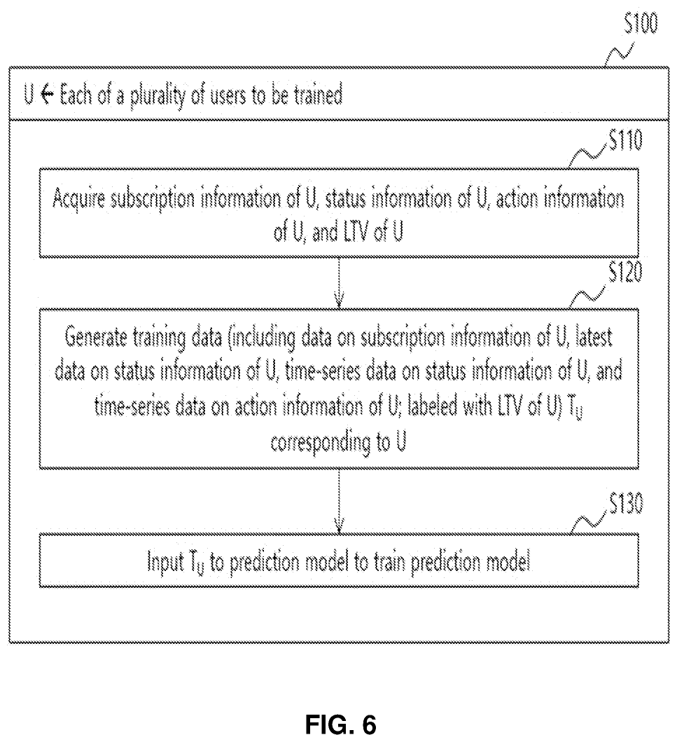

FIG. 6 is a diagram illustrating a method for training a prediction model for predicting life time value of a user playing a mobile F2P game in accordance with an embodiment of the present disclosure.

Referring to FIG. 6, the computing system 100 storing the prediction model 300 for predicting the life time value of the user may acquire, for each of a plurality of users to be trained (S100), subscription information, action information, and status information of a user to be trained U.

The computing system 100 may generate training data (containing data on subscription information of U, latest data on status information of U, time-series data on status information of U, and time-series data on action information of U; labeled with LTV of U) Tu corresponding to the user to be trained U (S120), and input this into the prediction model 300 to train the prediction model 300 (S130).

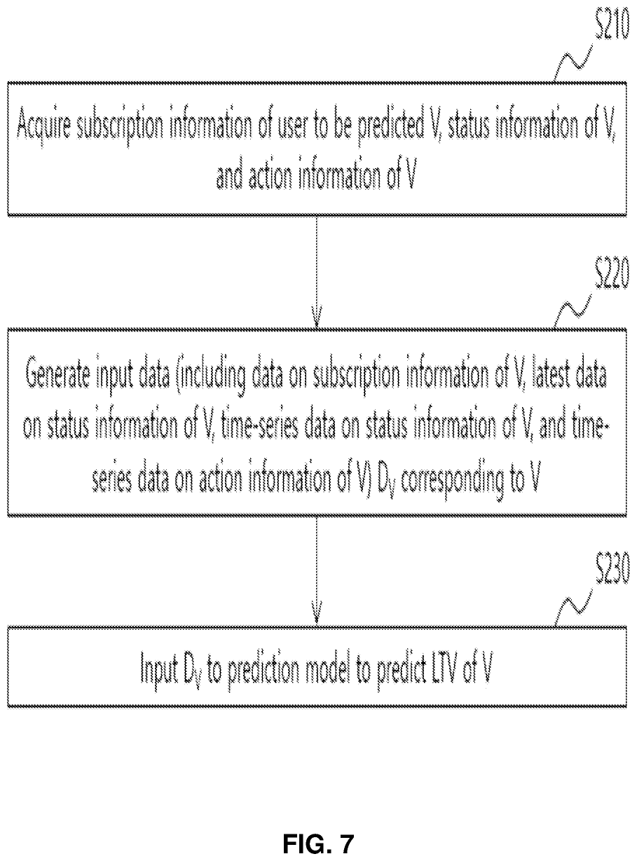

FIG. 7 is a diagram illustrating an example of a method for predicting the life time value of the user playing the mobile F2P game using the prediction model 300 previously trained through the process of FIG. 6.

The computing system 100 may acquire subscription information of a user to be predicted V, status information of V, and action information of V (S210).

The computing system 100 may generate input data (containing data on subscription information of V, latest data on status information of V, time-series data on status information of V, and time-series data on action information of V) Dv corresponding to the user to be predicted V (S220), and input this into the prediction model 300 to predict LTV of the user to be predicted V (S230).

In addition, according to implementation examples, the computing system 100 may include a processor and a memory storing a program executed by the processor. The processor may include a single-core CPU or a multi-core CPU. The memory may include a high-speed random access memory and may include a non-volatile memory such as one or more magnetic disk storage devices, flash memory devices, or other non-volatile solid state memory devices. Access to the memory by the processor and other components may be controlled by the memory controller.

Meanwhile, the method of training a prediction model and/or the method of predicting life time value of a user according to an embodiment of the present disclosure may be implemented in the form of computer-readable program instructions and stored in a non-transitory computer-readable recording medium, and the control program and target program according to an embodiment of the present disclosure may also be stored in a non-transitory computer-readable recording medium. A non-transitory computer-readable recording medium includes all types of recording devices in which data that may be read by a computer system is stored.

Program instructions recorded on the recording medium may be those specifically designed and configured for the present disclosure, or may be known and available to those skilled in the software field.

Examples of the non-transitory computer-readable recording medium include magnetic media such as a hard disk, a floppy disk, and a magnetic tape, optical media such as a CD-ROM and a DVD, magneto-optical media such as a floptical disk, and hardware devices specially configured to store and perform program instructions such as a ROM, a RAM, and a flash memory. In addition, the non-transitory computer-readable recording medium is distributed in computer systems connected through a network, so that computer-readable codes may be stored and executed in a distributed manner.

Examples of program instructions include not only machine language code such as that created by a compiler, but also high-level language code that may be executed by a device that electronically processes information using an interpreter, for example, a computer.

The hardware devices described above may be configured to operate as one or more software modules to perform the operations of the present disclosure, and vice versa.

The above description of the present disclosure is for illustrative purposes, and those skilled in the art to which the present disclosure pertains will understand that the present disclosure may be easily modified into other specific forms without changing the technical idea or essential features of the present disclosure. Therefore, the embodiments described above should be understood in all respects as illustrative and not restrictive. For example, each component described as unitary may be implemented in a distributed manner, and similarly, components described as distributed may also be implemented in a combined form.

The scope of the present disclosure is indicated by the appended claims rather than the detailed description above, and all changes or modified forms derived from the meaning and scope of the claims and their equivalent concepts should be construed as being included in the scope of the present disclosure.

What is claimed is:

1. A computing system for predicting life time value (LTV) of a user playing a mobile F2P game, the computing system comprising:
a storage module configured to store a prediction model for predicting LTV of a user;
an acquisition module configured to acquire subscription information of a user to be predicted, which is input by the user to be predicted or obtainable from a terminal of the user to be predicted at a point of time when the user to be predicted subscribes to a service providing the mobile F2P game, action information, which is information indicating that the user to be predicted has performed various actions within the mobile F2P game over a predetermined period of time, and status information, which is various numerical information about the user to be predicted managed within the mobile F2P game; and
a prediction module configured to input data on the subscription information of the user to be predicted, latest data on the status information of the user to be predicted, time-series data on the status information of the user to be predicted, and time-series data on the action information of the user to be predicted to the prediction model, and predict LTV of the user to be predicted based on a result output by the prediction model,
wherein the prediction model comprises:
a first deep neural network (DNN) configured to receive the data on the subscription information of the user to be predicted through an input layer;
an autoencoder configured to receive the latest data on the status information of the user to be predicted through an input layer;
a first convolution layer configured to receive the time-series data on the status information of the user to be predicted; a first UNET configured to receive data output from the first convolution layer through an input layer; a first dense layer connected to an output layer of the first UNET;
a first Time2Vec layer configured to receive the time-series data on the status information of the user to be predicted; a first multi-layer transformer configured to receive data output from the first Time2Vec layer through an input layer; a second DNN configured to receive data output from the first multi-layer transformer through an input layer;
a first weighted sum layer for calculating a weighted sum of data output from the first dense layer and data output from the second DNN;
a second convolution layer configured to receive the time-series data on the action information of the user to be predicted; a second UNET configured to receive data output from the second convolution layer through an input layer; a second dense layer connected to an output layer of the second UNET;
a second Time2Vec layer configured to receive the time-series data on the action information of the user to be predicted; a second multi-layer transformer configured to receive data output from the second Time2Vec layer through an input layer; a third DNN configured to receive data output from the second multi-layer transformer through an input layer;
a second weighted sum layer for calculating a weighted sum of data output from the second dense layer and data output from the third DNN;
a concatenation layer for concatenating data output from the first DNN, data output from the autoencoder, data output from the first weighted sum layer, and data output from the second weighted sum layer;
a skip-connected autoencoder configured to receive data output from the concatenation layer through an input layer; and
a third dense layer connected to an output layer of the skip-connected autoencoder.

2. The computing system of claim 1, wherein the subscription information of the user to be predicted comprises at least some of country, language, operating system, and inflow path,
the action information of the user to be predicted is an action value related to the user to be predicted performing each of a plurality of actions of interest that the user to be predicted is able to perform within the mobile F2P game over a predetermined period of time, and
the status information of the user to be predicted is a plurality of status values related to the user to be predicted measured when the user to be predicted performs each of the plurality of actions of interest, and
wherein the plurality of actions of interest comprise at least some of action of playing a slot machine by paying a predetermined amount of coins held, action of purchasing in-game goods by paying cash, action of logging into a game, action of receiving rewards from various events, action of completing daily missions to increase user re-connection, action of watching in-game advertisements, action of using in-game chat, action of sharing game screenshots through SNS, action related to in-game friends, action related to subscribed clubs, action related to in-game pop-ups, action of clicking within the game, action related to in-app messages, action of entering the slot machine, and action of entering an in-game screen other than the slot machine, and
the plurality of status values comprise at least some of coins held, level, LTV, the number of purchases, coin acquisition amount, the number of level-ups, time taken from the last logout to a recent login, tier, total game activity time, the number of friends, and respective values of detailed statistics.

3. The computing system of claim 1, wherein, in the remaining layers except the third dense layer among the layers constituting the prediction model,
a kernel initializer is set to He_Normal, and
an activation function is set to LeakyReLU.

4. The computing system of claim 1, wherein the third dense layer is configured to output all prediction results for LTV from day 1 to day N, where N is a size of the third dense layer.

5. The computing system of claim 1, wherein the computing system further comprises a training module configured to train the prediction model by inputting each of a plurality of training data into the prediction model, and
wherein each of the plurality of training data comprises data on subscription information of a corresponding user to be trained, latest data on status information of the user to be trained, time-series data on the status information of the user to be trained, and time-series data on action information of the user to be trained, and LTV of the user to be trained is used as a prediction value of the prediction model.

6. A computing system for training a prediction model for predicting life time value (LTV) of a user playing a mobile F2P game, the computing system comprising:
a storage module configured to store a prediction model for predicting LTV of a user;
an acquisition module configured to acquire subscription information, action information, and status information of each of a plurality of users to be trained; and
a training module configured to train the prediction model by inputting training data corresponding to each of the plurality of users to be trained into the prediction model,
wherein the training data corresponding to the user to be trained comprises data on the subscription information of the user to be trained, latest data on the status information of the user to be trained, time-series data on the status information of the user to be trained, and time-series data on the action information of the user to be trained, and LTV of the user to be trained is used as a prediction value of the prediction model,
wherein the subscription information of the user to be trained is information which is input by the user to be trained or obtainable from a terminal of the user to be trained at a point of time when the user to be trained subscribes to a service providing the mobile F2P game,
the action information of the user to be trained is information indicating that the user to be trained has performed various actions within the mobile F2P game over a predetermined period of time, and
the status information of the user to be trained is various numerical information about the user to be trained managed within the mobile F2P game, and
wherein the prediction model comprises:
a first deep neural network (DNN) configured to receive data on subscription information of a user to be predicted through an input layer;
an autoencoder configured to receive latest data on status information of the user to be predicted through an input layer;
a first convolution layer configured to receive time-series data on the status information of the user to be predicted; a first UNET configured to receive data output from the first convolution layer through an input layer; a first dense layer connected to an output layer of the first UNET;
a first Time2Vec layer configured to receive time-series data on the status information of the user to be predicted; a first multi-layer transformer configured to receive data output from the first Time2Vec layer through an input layer; a second DNN configured to receive data output from the first multi-layer transformer through an input layer;
a first weighted sum layer for calculating a weighted sum of data output from the first dense layer and data output from the second DNN;
a second convolution layer configured to receive time-series data on action information of the user to be predicted; a second UNET configured to receive data output from the second convolution layer through an input layer; a second dense layer connected to an output layer of the second UNET;
a second Time2Vec layer configured to receive the time-series data on the action information of the user to be predicted; a second multi-layer transformer configured to receive data output from the second Time2Vec layer through an input layer; a third DNN configured to receive data output from the second multi-layer transformer through an input layer;
a second weighted sum layer for calculating a weighted sum of data output from the second dense layer and data output from the third DNN;
a concatenation layer for concatenating data output from the first DNN, data output from the autoencoder, data output from the first weighted sum layer, and data output from the second weighted sum layer;
a skip-connected autoencoder configured to receive data output from the concatenation layer through an input layer; and
a third dense layer connected to an output layer of the skip-connected autoencoder.

7. A method for predicting life time value (LTV) of a user playing a mobile F2P game, the method comprising:
acquiring, by a computing system in which a prediction model for predicting LTV of a user, subscription information of a user to be predicted, which is input by the user to be predicted or obtainable from a terminal of the user to be predicted at a point of time when the user to be predicted subscribes to a service providing the mobile F2P game, action information, which is the number of times the user to be predicted performed various actions within the mobile F2P game over a predetermined period of time, and status information, which is various numerical information about the user to be predicted managed within the mobile F2P game; and
inputting, to the prediction model, data on the subscription information of the user to be predicted, latest data on the status information of the user to be predicted, time-series data on the status information of the user to be predicted, and time-series data on the action information of the user to be predicted, and predicting LTV of the user to be predicted based on a result output by the prediction model,
wherein the prediction model comprises:
a first deep neural network (DNN) configured to receive the data on the subscription information of the user to be predicted through an input layer;
an autoencoder configured to receive the latest data on the status information of the user to be predicted through an input layer;
a first convolution layer configured to receive the time-series data on the status information of the user to be predicted; a first UNET configured to receive data output from the first convolution layer through an input layer; a first dense layer connected to an output layer of the first UNET;
a first Time2Vec layer configured to receive the time-series data on the status information of the user to be predicted; a first multi-layer transformer configured to receive data output from the first Time2Vec layer through an input layer; a second DNN configured to receive data output from the first multi-layer transformer through an input layer;
a first weighted sum layer for calculating a weighted sum of data output from the first dense layer and data output from the second DNN;
a second convolution layer configured to receive the time-series data on the action information of the user to be predicted; a second UNET configured to receive data output from the second convolution layer through an input layer; a second dense layer connected to an output layer of the second UNET;
a second Time2Vec layer configured to receive the time-series data on the action information of the user to be predicted; a second multi-layer transformer configured to receive data output from the second Time2Vec layer through an input layer; a third DNN configured to receive data output from the second multi-layer transformer through an input layer;
a second weighted sum layer for calculating a weighted sum of data output from the second dense layer and data output from the third DNN;
a concatenation layer for concatenating data output from the first DNN, data output from the autoencoder, data output from the first weighted sum layer, and data output from the second weighted sum layer;
a skip-connected autoencoder configured to receive data output from the concatenation layer through an input layer; and
a third dense layer connected to an output layer of the skip-connected autoencoder.

8. The method of claim 7, wherein the subscription information of the user to be predicted comprises at least some of country, language, operating system, and inflow path,
the action information of the user to be predicted is information on the user to be predicted performing each of a plurality of actions of interest that the user to be predicted is able to perform within the mobile F2P game over a predetermined period of time, and
the status information of the user to be predicted is a plurality of status values related to the user to be predicted measured when the user to be predicted performs each of the plurality of actions of interest, and
wherein the plurality of actions of interest comprise at least some of action of playing a slot machine by paying a predetermined amount of coins held, action of purchasing in-game goods by paying cash, action of logging into the game, action of receiving rewards from various events, action of completing daily missions to increase user re-connection, action of watching in-game advertisements, action of using in-game chat, action of sharing game screenshots through SNS, action related to in-game friends, action related to subscribed clubs, action related to in-game pop-ups, action of clicking within the game, action related to in-app messages, action of entering the slot machine, and action of entering an in-game screen other than the slot machine, and
the plurality of status values comprise at least some of coins held, level, LTV, the number of purchases, coin acquisition amount, the number of level-ups, time taken from the last logout to a recent login, tier, total game activity time, the number of friends, and respective values of detailed statistics.

9. The method of claim 7, wherein, in the remaining layers except the third dense layer among the layers constituting the prediction model,
a kernel initializer is set to He_Normal, and
an activation function is set to LeakyReLU.

10. The method of claim 7, wherein the third dense layer is configured to output all prediction results for LTV from day 1 to day N, where N is a size of the third dense layer.

11. The method of claim 7, further comprising:
acquiring a plurality of training data; and
training the prediction model by inputting each of the plurality of training data into the prediction model,
wherein each of the training data comprises data on subscription information of a corresponding user to be trained, latest data on status information of the user to be trained, time-series data on the status information of the user to be trained, and time-series data on action information of the user to be trained, and LTV of the user to be trained is used as a prediction value of the prediction model.

12. A method for training a prediction model for predicting life time value (LTV) of a user playing a mobile F2P game, the method comprising:
acquiring, by a computing system storing a prediction model for predicting LTV of a user, subscription information, action information, and status information of each of a plurality of users to be trained; and
training the prediction model by inputting training data corresponding to each of the plurality of users to be trained into the prediction model,
wherein the training data corresponding to the user to be trained comprises data on the subscription information of the user to be trained, latest data on the status information of the user to be trained, time-series data on the status information of the user to be trained, and time-series data on the action information of the user to be trained, and LTV of the user to be trained is used as a prediction value of the prediction model,
wherein the subscription information of the user to be trained is information which is input by the user to be trained or obtainable from a terminal of the user to be trained at a point of time when the user to be trained subscribes to a service providing the mobile F2P game,
the action information of the user to be trained is information indicating that the user to be trained has performed various actions within the mobile F2P game over a predetermined period of time, and
the status information of the user to be trained is various numerical information about the user to be trained managed within the mobile F2P game, and
wherein the prediction model comprises:
a first deep neural network (DNN) configured to receive data on subscription information of a user to be predicted through an input layer;
an autoencoder configured to receive latest data on status information of the user to be predicted through an input layer;
a first convolution layer configured to receive time-series data on the status information of the user to be predicted; a first UNET configured to receive data output from the first convolution layer through an input layer; a first dense layer connected to an output layer of the first UNET;
a first Time2Vec layer configured to receive the time-series data on the status information of the user to be predicted; a first multi-layer transformer configured to receive data output from the first Time2Vec layer through an input layer; a second DNN configured to receive data output from the first multi-layer transformer through an input layer;
a first weighted sum layer for calculating a weighted sum of data output from the first dense layer and data output from the second DNN;
a second convolution layer configured to receive time-series data on action information of the user to be predicted; a second UNET configured to receive data output from the second convolution layer through an input layer; a second dense layer connected to an output layer of the second UNET;
a second Time2Vec layer configured to receive the time-series data on the action information of the user to be predicted; a second multi-layer transformer configured to receive data output from the second Time2Vec layer through an input layer; a third DNN configured to receive data output from the second multi-layer transformer through an input layer;
a second weighted sum layer for calculating a weighted sum of data output from the second dense layer and data output from the third DNN;
a concatenation layer for concatenating data output from the first DNN, data output from the autoencoder, data output from the first weighted sum layer, and data output from the second weighted sum layer;
a skip-connected autoencoder configured to receive data output from the concatenation layer through an input layer; and
a third dense layer connected to an output layer of the skip-connected autoencoder.

13. A computer program installed in a data processing device and recorded on a non-transitory recording medium for performing the method of any one of claim 7.

14. A computing system comprising:
a processor; and
a memory,
wherein the memory is configured to store a program which, when executed by the processor, causes the computing system to perform the method of any one of claim 7.

15. A computer program installed in a data processing device and recorded on a non-transitory recording medium for performing the method of any one of claim 12.

16. A computing system comprising:
a processor; and
a memory,
wherein the memory is configured to store a program which, when executed by the processor, causes the computing system to perform the method of any one of claim 12.
